(19) United States
(12) Patent Application Publication
(10) Pub. No.: US 2025/0038290 A1
(43) Pub. Date: Jan. 30, 2025

(54) METHOD AND FACILITY FOR RECYCLING BATTERY CELLS OR PARTS THEREOF

(71) Applicant: Reelements GMBH, Radebeul (DE)

(72) Inventor: Robert JÜTTNER, Moritzburg OT Reichenberg (DE)

(21) Appl. No.: 18/915,967

(22) Filed: Oct. 15, 2024

Related U.S. Application Data
(63) Continuation of application No. PCT/EP2023/059417, filed on Apr. 11, 2023.

(30) Foreign Application Priority Data
Apr. 13, 2022 (DE) 10 2022 203 761.8

(51) Int. Cl. H01M 10/54; B09B 3/35; B09B 3/38; B09B 3/80; B09B 101/16

(52) U.S. Cl. CPC H01M 10/54; B09B 3/35; B09B 3/38; B09B 3/80; B09B 2101/16

(57) ABSTRACT

A method and a facility for recycling rechargeable battery cells or parts thereof which have electrolyte, lithium, and foils provided with coating material, namely cathode films with a coating made of a cathode material and anode films with a coating made of an anode material. The cells are mechanically pre-comminuted in a shredder stage, in particular in a liquid medium, to obtain a shredder fraction. The shredder fraction is then rinsed in a pre-separation stage using a mechanical separator, such as a stirrer under the effect of mechanical energy and using a liquid medium. The foils are thereby individualized (singulated) and constituents are rinsed out of the shredder fraction, such as electrolyte, coating material, and lithium, wherein the constituents are accumulated in the liquid medium. A separator fraction is obtained in the pre-separation stage, and the separator fraction is then further processed in at least one separation stage.

### CROSS-REFERENCE TO RELATED APPLICATION

This application is a continuation, under 35 U.S.C. § 120, of copending International Patent Application PCT/EP2023/059417, filed Apr. 11, 2023, which designated the United States; this application also claims the priority, under 35 U.S.C. § 119, of German Patent Application DE 10 2022 203 761.8, filed Apr. 13, 2022; the prior applications are herewith incorporated by reference in their entirety.

### FIELD AND BACKGROUND OF THE INVENTION

The invention relates to a method and to a facility for the recycling of battery cells or parts thereof. These cells or parts thereof comprise, among other things, electrolytes, and foils bearing a coating, these being cathode foils, with a coating of cathode material, and anode foils, with a coating of anode material. Depending on the battery type, the cells or parts thereof comprise further constituents as well: lithium in the case of lithium batteries, and nickel (nickel hydroxide) plus a metal hydride in the case of NiMH batteries.

In light of the increasing use especially of lithium batteries, including in particular in the motor vehicle industry, for electromobility, the recycling of such batteries is coming more and more into the spotlight.

German published patent application DE 10 2019 218 736 A1 discloses a method for the material-selective disintegration of lithium-ion batteries, in which the components are introduced into a liquid-filled container and are comminuted and parted with utilization of an electrohydraulic effect. In this method, a shock discharge is generated within the liquid within an underwater spark gap between a ground electrode and a high-voltage electrode by means of a pulsed current source. As a result of this shock discharge, portions at least of the coating material of the foils, that is the anode material or the cathode material, are removed. In subsequent parting and separating steps, the foils and the coating materials, parted from one another, can then be recovered and reused.

Generally, battery cells consist of an anode, a cathode, a separator, an electrolyte, and a casing. The anode and cathode are each typically formed here by a foil bearing a coating. On the anode side, this is typically a copper foil (anode foil), coated with graphite in the form of anode material. On the cathode side, this is typically an aluminum foil (cathode foil), coated typically with a coating, for example with a lithium nickel cobalt manganese mixed oxide (NMC), in the form of cathode material. Alternatively, a coating of LiCoO, NiCoO, LiFePO4 or other known coating materials is applied. The layer thickness of the foil coatings here is typically in the region of about 50 μm.

The electrolyte used in a lithium-ion battery (LIB) consists frequently of a conductive salt and of a mixture of volatile solvents and less volatile solvents, which in some cases are also solid at room temperature. The fraction of the conductive salt in the electrolyte is only a few percent, for example only one percent by volume. An example of a conductive salt used is LiPF6 (lithium hexafluorophosphate).

During battery charging, lithium ions migrate from the cathode through the separator foil to the anode, where they are deposited. During discharge, conversely, the lithium ions migrate from the anode to the cathode and are incorporated back into the cathode material. While the lithium ions are incorporated firmly in the cathode material, they are bonded on the anode side with low forces at most and are contained in largely free form in the electrolyte.

In the recycling of batteries, a typical first step is a rough mechanical dismantling, which may be done manually. Batteries consist typically of a plurality of interconnected modules, which in turn comprise a plurality of the above-described cells. The mechanical pre-comminution yields the cells, which are then supplied to the actual recycling process.

### SUMMARY OF THE INVENTION

In view of the above, it an object of the invention to provide a recycling method and facility which overcome a variety of disadvantages of the heretofore-known devices and methods of this general type and which enables a very efficient recycling of batteries or battery cells, especially of lithium-ion batteries (cells) or parts thereof, with a very high recovery rate of various substances of value that are contained in the cell.

With the above and other objects in view there is provided, in accordance with the invention, a method for recycling battery cells (Z) or parts thereof that contain electrolytes, lithium, and foils bearing coating material, such as cathode foils with a coating of cathode material and anode foils with a coating of anode material. The method comprises:
mechanically pre-comminuting the cells in liquid medium in a shredder stage to obtain a wet shredder fraction;
subsequently washing the wet shredder fraction in a preliminary separation stage, aided by a mechanical separator with exposure to mechanical energy and with use of the liquid medium, and in the process singulating the foils and washing out constituents of the shredder fraction, such as electrolyte, coating material, and lithium, and accumulating the constituents in the liquid medium to obtain a separator fraction in the preliminary separation stage; and
subsequently processing the separator fraction in at least one parting stage.

The objects are achieved according to the invention by a method and a facility for recycling battery cells or parts thereof. The battery cells are more particularly cells of a lithium-ion battery. The advantages and preferred configurations set out below in relation to the method can also be transposed as and where appropriate to the facility, and vice versa.

Where the present text mentions batteries, this term is understood in particular to mean secondary batteries.

The facility comprises a shredder stage, preferably with a mechanical shredder, which provides for mechanical pre-comminution of the cells. The process here is more particularly one of wet shredding using a liquid medium. At the exit from the shredder stage, a (wet) shredder fraction is available. As a result of the mechanical pre-comminution, more particularly shredding, the foils are exposed and parted from the casing of the cells. Shredders are understood presently to refer, generally, to apparatuses with the aid of which comminution takes place with mechanical comminution apparatuses, such as grinding units, sharing units, cutting units, hammer units, etc. The term is presently extended to include, in a further sense, rotary shears, guillotines, etc.

The foils contained in the shredder fraction preferably have a size in the range from 0.3 cm to 10 cm. This size is highly suitable in particular for the downstream electrohydraulic parting apparatus.

Subsequent to the shredder stage along the processing sequence, the facility comprises a preliminary separation stage with a mechanical separator, which is embodied more particularly as a stirrer. The shredder fraction, in particular together with the liquid medium, is washed in this mechanical separator with exposure to mechanical energy with the aid of a liquid medium, more particularly the liquid medium from the shredder stage, which is referred to below, without restricting the general nature of the term, as process water. The mechanical exposure in combination with the washing by the process water achieves a number of advantages: firstly, there is an advantageous singulation of the foils, which are still tightly packed in the cell. As a result, the surfaces of the foils are more readily accessible in the subsequent process steps, and the subsequent parting and recycling steps can therefore be carried out with less effort and more efficiently.

At the same time, studies have shown that—alongside washing-out of the electrolyte—in an advantageous way at least part of the anode material, that is more particularly of the graphite, is also abraded from the anode foils and taken up by the process water. The efficiency of the subsequent recycling steps is improved in this way as well.

Lastly, the washing also results in—in the case of lithium-ion batteries—the unbound lithium or, generally, ions being taken up in the process water. At the end of the mechanical separator there is a wet separator fraction present. This fraction contains the process water, with the constituents contained therein, and also the shredded foils, at least partly still bearing the coating material.

This separator fraction is subsequently supplied at least to a further parting stage, where it is processed further. Specifically, it is supplied to an electrohydraulic parting apparatus, as disclosed for example by the above-mentioned German published patent application DE 10 2019 218 736 A1. In this parting stage, there is in particular a division into one or more coarse fractions, which contain, in particular, foil parts and casing parts, and into a fine fraction, which comprises process water with particles floating therein.

The facility is designed at least for the recycling of cells or parts thereof. However, the facility may also be supplied with modules or complete batteries for recycling. For this purpose, for example, there is additionally at least one dismantling stage upstream of the shredder stage, where the modules or the batteries undergo initial dismantling and comminution. Alternatively, the shredder stage is also supplied with larger units, such as modules, for example, which are comminuted there.

The mechanical separator is preferably embodied as a stirrer which comprises a stirring mechanism. The stirrer here encompasses, generally, a container in which the shredder fraction is introduced. The stirring mechanism rotates within the container, with simultaneous introduction of the liquid medium, which is introduced by spraying, for example. Alternatively to this or additionally, the container is filled at least partly with the process water, so that the stirring takes place directly in the process water. Mechanical energy is introduced in a simple way by the stirrer and leads to the desired removal of the anode material from the anode foils. It also supports the washing-out of the lithium. Lastly, the mechanical movement of the stirring mechanism leads in a particularly efficient way to the desired singulation of the foils.

Alternatively to a stirrer with stirring mechanism, other combined washing and parting apparatuses are also possible in principle; for example, a rotating drum may be provided and/or the process water is jetted under high pressure through corresponding nozzles onto the shredder fraction, resulting in the desired singulation and the extractive washing by means of the jet pressure of the water.

The mechanical separator is preferably disposed directly beneath the shredder, so that the shredder fraction can fall from above into the mechanical separator.

The residence time of the shredder fraction within the mechanical separator, i.e. specifically also a stirring time, here is typically in the range of a few minutes, for example 20 seconds to 5 minutes.

In one preferred configuration, the wet separator fraction is dewatered, for which at least part of the liquid medium with the constituents contained therein (particles and dissolved substances) is removed. After the dewatering, therefore, a dewatered separator fraction is available for further treatment specifically in the electrohydraulic parting apparatus. It is considered a particular advantage of this dewatering that species including the ions contained in the process water, lithium ions for example, are carried out as well, so that the fraction of these conductive elements is reduced for the subsequent process step. Indeed, studies have shown that the mode of action and the efficiency of the subsequent electrohydraulic parting apparatus are adversely affected with increasing conductivity. The conductivity is generally governed by ions dissolved in the process water. In general terms, this upstream dewatering has particular advantages for subsequent, wet parting steps by means of electrical methods.

For the dewatering, for example, a sieving apparatus is used, through which the process water can pass, leaving the dewatered separator fraction.

In a preferred embodiment, the dewatering is accomplished by way of a conveying device, specifically a conveying screw, via which the separator fraction is transported to the subsequent recycling stage. In particular, the conveying device is inclined, so that the process water is able to run downward conter to the conveying direction, where it can be collected. As a result, particularly simple and efficient dewatering is achieved, without need for an additional dewatering apparatus.

In a preferred development, constituents present in the process water (liquid medium) removed are recovered from it. In particular, lithium and/or anode material (graphite) is recovered from the process water removed. This is accomplished in particular in a suitable processing device for the process water (liquid medium), which is supplied (again) preferably as processed process water to the mechanical separator (e.g., stirrer) and more particularly to the shredder stage, as the liquid medium. As a result, the (partial) recovery of lithium and/or of graphite achieved is already very simple and efficient.

For the processing, a part of the process water removed is supplied to the processing device, for example, by way of a branch conduit, either continuously or recurringly. As an alternative to this, the entire process water removed is supplied continuously to the processing device.

As already mentioned above, the pre-comminution in the shredder stage already takes place preferably in the liquid medium.

According to one alternative configuration, the pre-comminution takes place only dry, without addition of a liquid medium. That is, it should be understood that the invention may also be framed by an independent claim that does not utilize a liquid medium in the shredder stage, in which the cells in the shredder stage are comminuted dry.

In the case of the preferred wet shredding, either the liquid medium is sprayed into the facility for pre-comminution, that is, specifically, the shredder, or the latter is filled with the liquid medium. This pre-comminution in the liquid medium, generally water or an aqueous solution, has the advantage that the electrolyte constituents released and also, for example, free (lithium) ions are bound immediately. This wet comminution process has further advantages over conventional, dry shredder processes, especially as follows:
Because of the immersion of the cells or parts thereof to be recycled into the process water, a protective gas atmosphere is initially neither needed nor provided either, since the process water effectively prevents the incidence of fires in the case of batteries which are partially still charged.
This approach ensures a dust-free comminuting procedure.
The operation additionally takes place preferably at room temperature, whereas dry shredder processes customarily require high temperatures of 80° C. or more in order to remove the electrolytes from the gas phase.
As a result of the wet comminution, the electrolytes, the conductive salt contained therein and also the (free) lithium ions are taken up by the process water and/or dissolved therein in the shredder stage itself. In contrast to this, with dry shredder processes, only volatile gases are removed, whereas the relatively non-volatile constituents of the electrolyte, and the conductive salts, dry up and are carried further through the recycling process with the so-called black mass, that is the solids removed. This results in the latent risk of formation of hydrofluoric acid (HF).
A further advantage of the wet process is that the electrolytes are retained in their chemical structure. They are preferably recycled and reused as and when required.
A particular advantage is further considered to be the fact that lithium is taken up by the process water, and can therefore be recovered, already in an early step in the process.
Lastly, any residual electrical energy contained in the cell is able to discharge within the process water without problems. Firstly, this has the effect that, in contrast to conventional processes, to be able to omit prior discharge of the battery, which preferably also is omitted. Furthermore, the heat taken up by the process water as a result can be utilized as process heat in the facility itself.

The comminution in the shredder stage in a liquid medium is regarded—separately from the use of the mechanical separator more particularly in the form of a stirrer—as an independent invention, and the right to the filing of a divisional application therefor is reserved. The essential steps in this regard are the comminuting in a liquid medium to achieve a wet shredder fraction, supplying of the shredder fraction to a downstream recycling stage, specifically an electrohydraulic parting apparatus, namely in particular also without interposition of the mechanical separator (stirrer).

Also regarded as independently inventive, therefore, is a features combination analogous to claim 1, but in which the feature of the preliminary separation stage is not actualized. All further herein-described advantages and preferred configurations can be combined therewith.

These advantages described above in connection with the wet shredding are also valid in particular for the above-described wet preliminary separation stage by means of the mechanical separator.

The liquid medium generally preferably is water. It is supplied, continuously in particular, to the shredder stage. The water is taken out from the shredder preferably together with the shredder fraction and supplied as wet shredder fraction to the mechanical separator.

Where water is referred to presently, it is understood to mean that at least largely pure water is supplied to the process, in other words, specifically, to the shredder stage or the preliminary separation stage. The fraction of the water is at least 98%, preferably at least 99%. The remainder may be, for example, ions, minerals, etc. that are contained in the water. Water used is, for example, mains water or else deionized or distilled (pure) water. The water supplied preferably has an at least largely neutral pH, which is therefore preferably in the range between 6.5 and 7.5 and preferably is 7.0±0.2. The process water supplied is therefore specifically not an acid or an alkali. No acid and no alkali either are supplied to the water, and—aside from the cells or parts thereof to be comminuted—no admixtures are introduced in order, for example, to react with the water so as to form an acid or alkali, for example.

The use of standard water allows a process regime overall to be simple and cost-effective.

The shredding and/or the preliminary separation in the preliminary separation stage additionally take place preferably at ambient temperature. There is no provision for either active cooling by a cooling device or active heating by a heating device.

Preferably, overall, a large quantity of liquid medium, more particularly water, is used for the mechanical separator and in particular for the shredder stage itself as well. The weight fraction of the water is preferably greater at least by the factor of 10, more preferably by at least the factor of 30 and more particularly by at least the factor of 50, than the weight fraction of the cells or the parts of the cells. As a result of this large quantity, the advantages stated above for the wet treatment are achieved to particularly good effect.

The shredding takes place preferably under water, meaning that the material to be shredded is immersed completely in a water bath. The same is preferably also true of the further treatment, in particular the stirring, in the preliminary separation stage.

Overall, a wet shredder fraction is discharged from the shredder stage and supplied preferably directly, without further treatment, to the preliminary separation stage and the mechanical separator. The proportion of water with respect to the shredded fractions of the cells is preferably the same as indicated above for the shredder stage. With preference, therefore, process water is supplied constantly to the shredder stage and discharged again in equal quantity together with the shredded fractions, and supplied to the preliminary separation stage as the wet shredder fraction.

As already remarked above, because of the wet treatment, there is no need for discharge of the battery and hence of the cells, and in a preferred configuration no such discharge is provided either. As a result, therefore, an otherwise necessary discharging step is removed. This also makes it possible—depending on the state of charge—for a high fraction of lithium to be recovered simply by way of the process water.

In order to recover a very high lithium fraction in a simple way, in a useful configuration, it is provided that the batteries/cells are brought to a defined state of charge before the comminution of the battery and the cells, i.e., in particular, before the shredder stage. For this purpose, in particular, charging of the battery is envisaged. The defined state of charge here is for example at least 30%, at least 50%, at least 75% or else at least 90% or 100% of a maximum state of charge. The higher the state of charge, the more free lithium ions there are, which can be leached out with the process water. The state of charge (SOC) is understood generally to be the prevailing capacity of a battery, as a percentage in relation to its maximum capacity. The maximum capacity of a battery indicates the amount of electrical charge which the battery is able to store at maximum. It is reported typically in ampere hours (Ah).

This measure for the recovery of lithium is regarded as an independently inventive aspect. The right of filing of a divisional application therefor is reserved. The primarily important method steps for this purpose are:
the comminuting, especially shredding, in a wet environment (in the process water)
subsequent removal of the process water, with recovery of the lithium thereafter.

In a preferred development, this takes place in particular with non-discharged batteries and in particular—as described above—the establishment of a defined state of charge is envisaged. All further process steps described within this application are, in a preferred development, combined individually or in combination with this concept.

As already mentioned a number of times, the dewatered separator fraction—or, in the case of a variant in which the preliminary separation stage is omitted, a dewatered shredder fraction—is supplied in a (first) parting stage to the already mentioned (first) electrohydraulic parting apparatus. This apparatus generally comprises a bath which is part-full of a liquid medium (process water) and into which the dewatered separator fraction is introduced. The parting apparatus is constructed in particular according to the above-mentioned German publication DE 10 2019 218 736 A1. It comprises a ground electrode and a high-voltage electrode, which are driven appropriately so that regular shock discharges are generated. As well as comminuting the fraction introduced, these discharges also lead to the removal of the coating material from the foil. By setting the process parameters (pulse time of the shock discharges, pulse energy, etc.), it is possible here in a targeted way to remove the coating material either from the anode foil or from the cathode foil. In the first parting stage, therefore, the corresponding coating material is typically removed only from one foil material. As already mentioned, the material in question here is preferably the anode material, i.e., specifically graphite. At the end of the first parting stage, a first parting fraction is present.

In a preferred development, this first parting fraction, which more particularly is a wet fraction, is parted into a coarse fraction and a fine fraction. The coarse fraction comprises coarse foil parts and the fine fraction comprises the coating material removed and also other fine parts, such as foil parts, for example. These components of the fine fraction are contained in particular in the process water. The two fractions (coarse fraction and fine fraction) are subsequently processed further separately.

As part of this more extensive working, the two different foil fractions of the coarse fraction that were obtained in the first parting stage are parted from one another, and the foil fraction, which continues to comprise its coating, in other words, specifically, the cathode foil with the cathode material (e.g., NMC), is supplied in a second parting stage to a second parting apparatus, for which, in turn, an electrohydraulic (second) parting apparatus is employed in particular. This apparatus is fundamentally constructed similarly or identically to the first electrohydraulic parting apparatus, wherein preferably only the process parameters are altered and are set in such a way that the cathode material is removed from the cathode foil.

As a result, the cathode material, specifically NMC, is removed from the previously separated cathode foil fraction and obtained in high purity. It is subsequently recovered from the process water.

Dewatering, in particular also of the coarse fraction, with subsequent sorting into the two foil fractions, is provided preferably for the parting of the different constituents of the first parting fraction. The sorting may in principle also take place here wet, without prior dewatering. In the case of the dewatering of the coarse fraction, a centrifuge is preferably employed.

According to one useful development, parts of the fine fraction in the process water and/or the second parting fraction (i.e., primarily anode particles (graphite) and/or cathode particles (NMC)) are supplied to a further comminution stage and a (further) comminuting apparatus formed in particular by an electrohydraulic parting apparatus. In this case, a comminuted fine fraction is obtained.

For example, the parts of the fine fraction and/or parts of the second parting fraction are supplied again to the previous parting stage, more particularly the preceding electrohydraulic parting apparatus. Preferably, however, these parts are supplied to an additional, further comminuting apparatus, specifically a further electrohydraulic parting apparatus.

The parts are more particularly the coarse parts of the respective fraction. In order to supply them separately from the finer components to the (further) comminuting apparatus, there is preferably provision first for a classification of the respective fraction into different size classes, specifically into a coarse fine fraction, a fine fine fraction and an ultrafine fraction, in order to subsequent supply only the coarser components, more particularly the coarse fine fraction, to the (further) comminution stage and acquire the comminuted fine fraction.

This configuration is based on the consideration that the fine fraction of the first parting fraction after the first parting stage (after the first electrohydraulic parting apparatus) or else second parting fraction after the second parting stage (after the second electrohydraulic parting apparatus) still have comparatively large parts (greater than 50 μm, more particularly greater than 250 μm) of the comminuted particles (anode material/cathode material), where at least still partially further constituents adhere. These constituents include, in particular, a binder, such as PVDF or CMC, for example, which holds together the individual particles of the anode/cathode material. Alternatively or additionally, these constituents include a so-called conductive carbon black, in particular a kind of amorphous graphite, which is electrically conductive and which in the cells ensures that the current is passed through the coating to the respective foil. The fraction of the binder or of the conductive carbon black in this case is, for example, between 2% to 5%.

The comminuted fine fraction then preferably has a homogeneous particle size and generally preferably a particle size of less than 50 μm and more particularly of less than 40 μm or less than 30 μm. As a result of the further comminution, the unwanted adhering constituents (binder and conductive carbon black) are removed and the particles of the coating material (anode material, graphite, cathode material, NMC) are obtained in largely discrete form.

In a preferred development, it is provided that one or more of the fractions, selected from the fine fraction of the first parting stage, second parting fraction, the classified fractions obtained, or else the comminuted fine fraction, are supplied to a subsequent separation stage. Specifically, the fine fraction, or one or more of the classified fractions obtained therefrom, or the comminuted fraction(s) obtained, are supplied to the further separation stage. In this stage, different kinds of particles, i.e., in particular, particles of the anode material and particles of the cathode material, are parted from one another and separated.

This is based on the consideration and finding that, specifically in the first parting stage, the fine fraction obtained is not sufficiently discrete, meaning that the fine fraction contains not only the particles of one coating material (typically the anode material, graphite) but also particles of the other coating material (typically cathode material, NMC). Through the further separation stage, therefore, there is a further parting of the two coating materials from one another.

The further parting takes place here preferably with the aid of a centrifuge or with the aid of a so-called flotation process.

It is particularly advantageous if before this further parting, the fractions have been treated with the (further) comminuting apparatus and the comminuted fine fraction has been generated, which is then supplied to the further separation stage.

By means of the further comminuting apparatus, generally, the particles are comminuted to a very uniform size, thus simplifying the subsequent separation of the cathode and anode particles.

The apparatus used as (further) comminuting apparatus is preferably—as already mentioned—a further (third) electrohydraulic parting apparatus, as already described above.

Indeed, as a result of the shock waves, an electrohydraulic parting apparatus of this kind comminutes the material introduced and is capable of homogenizing the particle size distribution or parting different (interconnected) kinds of particles from one another. Depending on treatment time and/or pulse energy, the resulting fractions have different sizes. The preferred aftertreatment described here therefore involves deliberately exploiting this comminuting function in order to obtain a very uniform particle size distribution. The homogenized, comminuted fine fraction processed in this way is subsequently preferably dewatered and the various constituents (kinds of particles) are separated from one another and parted.

These aspects, on the one hand the downstream comminution by means of the (further) comminuting apparatus and on the other hand the downstream further separation stage, and in particular the combination thereof, are regarded in turn as being independent inventive aspects, and the right to file divisional applications therefor is reserved. The essential steps for the further comminution stage are:
supplying the fine fraction obtained from a parting stage to a comminuting apparatus, more particularly to a further, preferably electrohydraulic, parting and comminuting apparatus, to generate a comminuted fine fraction,
preferably subsequently dewatering and parting different kinds of particles in a further separation stage, in particular with the aid of a centrifuge or in a flotation or sedimentation process.

The primarily important steps for the further separation stage are:
supplying the fine fraction obtained from a parting stage (specifically from the first parting stage) to a further separation stage, in particular after dewatering, with the further separation stage being formed in particular by a centrifuge or a flotation process,
preferably, beforehand, classifying the fine fraction obtained from the parting stage into a plurality of classified fine fractions, with a plurality and/or each of the classified fine fractions being supplied to the further separation stage.

In a preferred development, the facility has a plurality of circuits for the liquid medium, which at least partly may also be combined with one another.

Specifically provided is a first circuit, incorporating at least the shredder and/or the mechanical separator (stirrer). A fraction of the graphite and in particular a fraction of the lithium are present in the process water of the first circuit and are recovered from it.

The second circuit comprises in particular the first parting stage with the electrohydraulic first parting apparatus, and the third circuit comprises the second separation stage with the second electrohydraulic parting apparatus.

The two latter circuits are preferably coupled to one another, specifically more particularly such that the process water of the third circuit is supplied to and used in the second circuit, and that the process water, after passing through the second circuit, is cleaned.

Other features which are considered as characteristic for the invention are set forth in the appended claims.

Although the invention is illustrated and described herein as embodied in a method and a facility for recycling battery cells or parts thereof, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1 shows, in detail form, a representation of a facility for recycling secondary battery cells, in the region of a shredder and a stirrer, which are incorporated in a first process water circuit;

FIG. 2 shows, in detail form, a representation of the facility in the region of a first electrohydraulic parting apparatus, which is incorporated in a second process water circuit; and

FIG. 3 shows, in detail form, a representation of the facility in the region of a second electrohydraulic parting apparatus, which is incorporated in a third process water circuit.

### DETAILED DESCRIPTION OF THE INVENTION

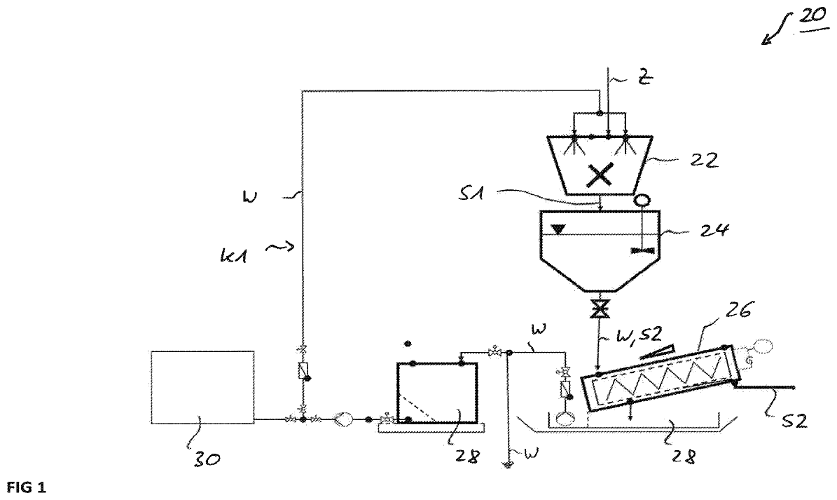

FIGS. 1-3 shows respective portions of an integrated facility 20.

FIG. 1 shows a first subsection, in which cells Z to be recycled, especially lithium cells of a lithium-ion battery, are subjected to pre-comminution and preliminary parting.

As primarily important components, the facility in this first subsection comprises a shredder 22, a stirrer 24 and a conveying device 26. A liquid medium, referred to presently as process water W, is carried in a first circuit K1. Arranged in this circuit are a plurality of pumps, valves, and intercepting or collecting containers 28. Further represented in FIG. 1, as a kind of black box, is a processing device 30 for processing the process water W and in particular for recovering constituents of the cells Z. Specifically, this processing device 30 recovers lithium and/or graphite. This device is generally coupled in after sieving and/or filter stages. The sieving or filter stages preferably filter out all particles larger than, for example, 5 μm, prior to the subsequent processing performed by the device. In this device, the remaining, extremely small particles are removed, and also substances dissolved in the process water, including, in particular, (lithium) ions.

Leaving the shredder 22 together with the process water W is a wet shredder fraction S1, which is supplied to the stirrer 24 and which then leaves it subsequently as a wet separator fraction S2.

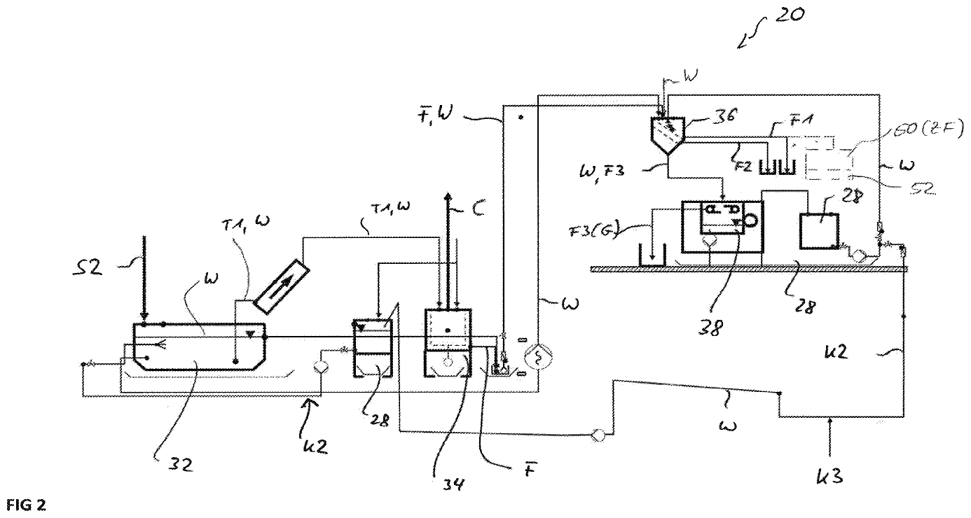

This fraction is transported by means of the conveying device 26 in the direction of the second subsection, which is represented in FIG. 2. In the course of transport by way of the conveying device 26, which is embodied in particular as an inclined conveying screw, the separator fraction S2 is dewatered.

This dewatered separator fraction S2 is supplied to a first electrohydraulic parting apparatus 32. In this second subsection of the facility 20, graphite G is removed from the comminuted anode foils (copper foils CU). The second subsection of the facility 20, subsequent to the first electrohydraulic parting apparatus 32, comprises multiple components for the drying/dewatering, sorting and classifying of the various fractions.

The first parting apparatus 32 is a bath full of process water W, into which the separator fraction S2 is introduced. In this bath, the separator fraction S2 is treated with high pulse energy with shock waves, with the process parameters being set in such a way that the graphite G is removed from the copper foil. The separator fraction S2 comminuted and treated in this process leaves the first parting apparatus 32 as a first parting fraction T1; specifically, it is pumped off from the bath together with the process water W and supplied to a centrifuge 34.

Taking place in the centrifuge 34 are dewatering and also removal of a coarse fraction C from a fine fraction F. The coarse fraction C contains, for example, particles having a diameter of not less than 0.5 cm or else not less than 1 cm. The fine fraction F, correspondingly, contains particles smaller than 0.5 cm or smaller than 1 cm.

The fine fraction F is subsequently classified and finally dried. For this, the fine fraction F together with the process water W is supplied, in the exemplary embodiment, to a sieving apparatus 36. In this apparatus, the process water W is removed, and a coarse fine fraction F1 and a fine fine fraction F2 are extracted and classified. The coarse fine fraction F1 comprises foil pieces, for example, having a size of greater than 250 μm, and the fine fine fraction comprises graphite or foil fragments having a size in the region of, for example, 50-250 μm. Even smaller constituents are supplied as an ultrafine fraction F3 with the process water W to a filter device 38. From this device, lastly, the ultrafine fraction F3 is obtained, comprising in particular graphite G with a particle diameter, for example, of less than 50 μm.

The process water W in the region of this second section of the facility 20 is carried in a second circuit K2.

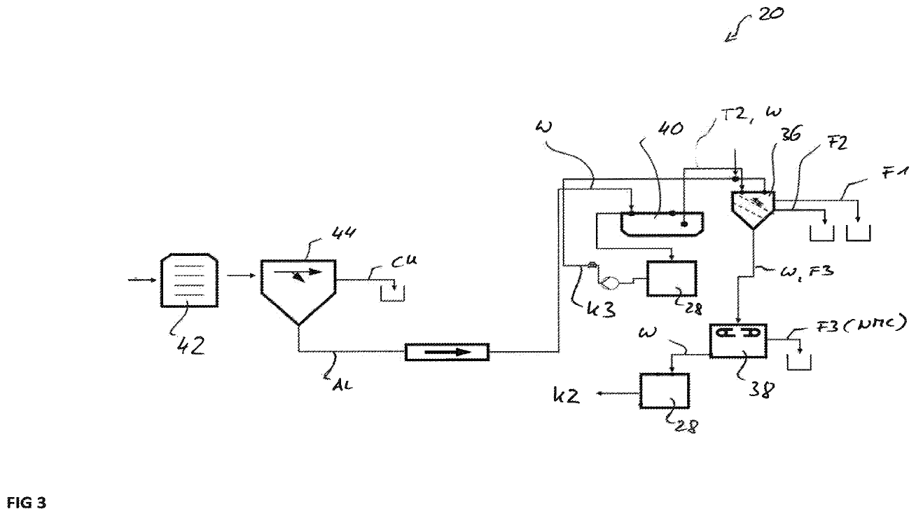

The coarse fraction C removed is supplied to the third subsection, as is represented in FIG. 3. This subsection also serves in particular for recovering NMC, that is the cathode material. For this purpose, in particular, a second parting apparatus 40 is provided, in which the NMC is removed from the cathode foil (aluminum foil). Before, the coarse fraction C is dried in a drying device 42 and subsequently, in an air classifier 44, for example, the different foil fractions are parted from one another, that is, on the one hand, a copper fraction CU containing copper foils and, on the other hand, an aluminum fraction containing the aluminum foils AL, which are still coated with the cathode material (NMC). In the case of the copper fraction CU, the separator foils are also present.

The aluminum fraction AL is supplied to the second electrohydraulic parting apparatus 40, in which now the process parameters have been set in such a way that the cathode material, more particularly NMC, is removed from the aluminum foils. According to cell type and cathode coating, other materials are used as well and are removed accordingly, such as, for example, NCA, LFP. The comminuted and treated aluminum fraction AL leaves the second parting apparatus 40 as a second parting fraction T2 together with the process water W, and is supplied to a further filter device 38. In this device, in turn, the process water W is removed together with an ultrafine fraction F3, and a coarse fine fraction F1 and a fine fine fraction F2 are removed. The coarse fine fraction F1 comprises in turn particles having a diameter of, for example, greater than 250 μm, and the fine fine fraction F2 particles having a diameter of between 50 and 250 μm. The fine fine fraction F2 consists here typically of at least highly enriched NMC. The ultrafine fraction F3 consists likewise of at least highly enriched NMC. This fraction, again with the process water W, is supplied to a filter device 38, where the ultrafine fraction F3 (NMC) is removed.

In FIG. 2, subsequently to the sieving apparatus 36, at least one further treatment stage is indicated with dashes, in particular for the coarse fine fraction F1:

Specifically, in a preferred configuration, this coarse fine fraction F1 is supplied in a further comminuting stage to a further comminuting apparatus, more particularly a third electrohydraulic parting apparatus 50. In this apparatus, the particles of the coarse fine fraction F1 are further comminuted and homogenized. At the same time, remaining binder fractions or conductive carbon black are also removed here. A comminuted fine fraction ZF is obtained here.

Additionally, it is also possible for another of the classified fine fractions F2, F3, more particularly the fine fine fraction F2, to be supplied to a further comminuting stage of this kind.

Further connected downstream of this further comminuting apparatus (in each case) is preferably a further separation stage, for example, in the form of a further centrifuge 52. In this stage, different types of particles, particularly of the cathode material, are parted from those of the anode material. After the first parting apparatus 32, indeed, the graphite fraction still contains in particular NMC levels of 10% to 20%, for example. This further separation stage therefore achieves improved discreteness.

A further separation stage of this kind is preferably also provided for one or more, or all, of the further classified fine fractions F2, F3. These need not necessarily be preceded by a further comminuting stage.

Alternatively, for example, the further comminuting stage is also arranged subsequent to the first parting apparatus 32, specifically in particular at a position after removal of the fine fraction F which is comminuted (i.e., before the classification) and from which the comminuted fine fraction ZF is then obtained.

Additionally or alternatively, a further comminuting stage of this kind, for treating the second parting fraction T2, is also arranged after the second parting apparatus 40, specifically either directly for treating the second parting fraction or—preferably—for treating one or more of the classified fine fractions F1, F2, F3, specifically for treating (only) the coarse fine fraction F1 and possibly also for treating the fine fine fraction F2. Since the second parting fraction T2 in general is already largely discrete, it is preferred here to forgo a further separation stage.

The process water is pumped in a third circuit K3 and thus continuously through the various components of the third section. In the exemplary embodiment, provision is made here for the third circuit K3 to be coupled to the second circuit K2. For this, the process water W obtained in the filter device 38 is supplied to the second circuit K2.

In a manner not represented in more detail here, spent process water W is supplied to a wastewater processing plant.

With regard to the facility 20 described here, the following aspects in particular should be especially emphasized:
As a result of the wet shredding, especially in combination with the wet stirring of the cells Z in the shredder 22 and the stirrer 24, the electrolytes, lithium ions and also even a fraction of the graphite are already removed with the process water W at this early stage and is obtained from the process water W in a simple and efficient way with the aid of the processing device 30. In other words, at this point already, lithium and graphite are obtained with high purity.
Preferably—in a manner not represented in detail here—the state of charge of the batteries and hence of the cells Z is adjusted in a defined way; in particular, prior to the comminution, the batteries/cells Z are deliberately electrically charged. This increases the “free” lithium ion fraction, meaning that a maximum lithium fraction is washed out with the process water W and recovered.
It should further be emphasized that through the use of the stirrer 24, a part of the graphite is already detached and already obtained at this point. Moreover, as a result of the stirrer 24, the otherwise densely packed foils are singulated, which is advantageous for the subsequent treatment in the electrohydraulic parting apparatuses 32, 40. Overall, as a result, the parting efficiency in respect of the removal of the coating material from the respective foil in the parting apparatuses 32, 40 is improved, thereby improving the degree of recovery. The latter, in the case of the facility described here, is typically greater than 90% for NMC.
Additionally to be emphasized is the dewatering of the wet separator fraction S2 before it is supplied to the first parting apparatus 32. As a result of this, indeed, the level of the free lithium ions in the process water W is reduced, with beneficial consequences for the operation of the first parting apparatus 32.

The overall recycling process with the individual method steps (hereinafter A . . . , B . . . , C . . . , D . . . , E . . . , W . . . ) and also the mode of action, functions, and also alternatives to the individual components, are apparent, moreover, from the detailed description, in the style of key points, below:

### A1 Dismantling of (Vehicle) Batteries

Vehicle batteries are dismantled (manually, semi-automatically or automatically), the modules removed, and remaining components (casing, cable, electronics) sorted and recycled separately as product streams.

### A2 Classifying of the Battery Modules

Battery modules are measured and classified (can be used for “2nd life applications” vs. recycling). Modules to be recycled undergo further preliminary sorting (e.g., according to kinds, chemical composition, any residual charge)

### A3 Adjusting State of Charge of the Battery Modules

Modules according to one variant are very largely or completely discharged by discharging apparatus. The power is fed back into the network and/or utilized for the recycling facility. Alternatively, entire vehicle batteries may also be discharged without prior disassembly of the modules.

For the present method, however, the state of charge is ignored, since the method allows the recycling of charged batteries, or a defined state of charge is established (e.g., very high charge by charging instead of the usual discharging), to allow as much lithium as possible to be extracted.

### A4 Disassembly/Pre-Comminution of Battery Modules

This processing step may be a manual, a semi-automatic, or automatic process. The battery modules are dismantled with the aim of removing the individual fractions (in particular, cells, casing parts, electronic parts included) as far as possible without mixing. Pure disassembly (deconstruction) steps may be employed (e.g., unscrewing, prying open), and also separative processes (sawing open, cutting open). The components (including cells) may remain intact or be damaged; the aim is absence of mixing. Dissolving of any adhesives, conductive pastes or the like that are present, by appropriate solvents.

As an alternative to this, the battery modules may also be shredded in liquid medium, for example, or comminuted with the aid of an electrohydraulic parting apparatus (for example, according to DE10 2019 218 736 A1) with very high pulse energy.

### B1 Pre-Comminution of Battery Cells Z in Liquid Medium

Shredding in the shredder 22:

The cells Z are coarsely shredded or cut into strips. This exposes the battery foils (anode, cathode) and on the one hand parts them from the casing; on the other hand, the electrolytes are leached out and very largely bound in the water.

There exist a plurality of advantages relative to dry shredder processes:
(1) No expensive protective gas atmosphere needed, since any residual energy present discharges in the water==> is utilizable as process heat in an industrial facility, for later steps.
(2) Operation at room temperature (rather than at 80° C. or even more)=energy-efficient
(3) All electrolytes and also conductive salt are safely dissolved in the water (vs. dry process: only the volatile gases are effectively removed; conductive salts and low-volatility constituents dry up and enter into black mass; this results in a permanent risk of formation of hydrofluoric acid (HF)).
(4) The electrolytes are retained here in their chemical structure and can later be themselves recycled.
(5) Fully or partly charged cells can also be treated accordingly discharging step can be omitted
(6) Lithium is dissolved in the water at this point already and can be recovered. With other processes, lithium remains in the black mass and can only be obtained much later in the process, or is lost (in pyrolytic processes)
(5)+ (6) the lithium content in the process water can be established in a targeted way through flowrate and through state of charge (charged cell most of the lithium is in the form of the free ion in the graphite and dissolves in the water; discharged cell: most of the lithium is chemically bound in the NMC and remains in the later black mass). As a result, it is possible through prior charging to recycle the lithium already in advance.

As an alternative to the conventional shredder, a rotary cutter or a guillotine can also be used: Severing or breaking into multiple large pieces. The object is to obtain fractions as large as possible, in order to achieve very good sorting of the casing parts and to lose as little black mass as possible in this step.

As a further alternative to the conventional shredder, the cells are opened automatically by precise cutting open on one or more predefined sides.

### B2: Preliminary Sorting of Battery Cell Pieces (Optional)

After the pre-comminution in step B1, the product stream consists of components as follows:
(1) Cathode foils of aluminum with active cathode mass (e.g., NMC, LFP, or others) very largely still adhering
(2) Anode foils of copper with active anode mass (usually graphite mixture) still partly or entirely adhering
(3) Separator foil
(4) Casing parts
(5) Fine fraction (predominantly graphite, with smaller fractions of active cathode mass, and foil particles)

In this step, firstly the resulting fine fractions are taken off and sorted/classified (e.g., by sieving, sink/swim sorting, centrifuging, magnetic deposition and/or eddy current deposition). This occurs in steps D1 and D3. Secondly, the coarse casing consitutents are sorted out (e.g. by sink/swim sorting, magnetic deposition and/or eddy current deposition). An advantage of only coarse comminution in B1 (relative to much finer comminution in other shredder processes): a higher percentage of casing parts can be removed by sorting.

### C1 Pretreatment of the Battery Cells (Electrolyte, Anode Delamination)

The shredded or precut cell materials are washed and stirred respectively (stirrer 24, essential aspect) in water for a certain time. The objects are:
(1) the singulation of the foils (still densely packed in the cell; through singulation, the surfaces of the foils are more readily accessible in the subsequent steps)
(2) dissolution/washing-out of the electrolyte
(3) ablation of the graphite from the anode foils
(4) dissolution/washing-out of the lithium
The advantages listed at 1-3 and 5 and 6 from B1 (Pre-comminution of battery cells Z in liquid medium) are applicable here as well.

The steps B1, B2 and C1 are connected by a common first process water circuit K1. This circuit has the greatest concentration of electrolyte and possibly also of graphite and dissolve lithium. After the step C1, there is a partial dewatering by means of the conveying device 26 conveying screw with integrated sieve. As a result, in the following step C2, the process water W has a much lower electrolyte content, and is also less conductive (since readily soluble constituents such as lithium ions and any unbound heavy metals are taken up already in the first circuit). Furthermore, the higher concentration of lithium and electrolyte in this first circuit is advantageous for the filtered extraction of these substances.

C2 Pretreatment, Shockwave Facility with High Pulse Energy (First Parting Apparatus 32)

The steps C2 and D1 to D6 are connected by a common second process water circuit K2. The advantages 1 to 3 and 5 and 6 from B1 are applicable here as well. As a result of the process steps B1 and C1, however, the concentration of electrolyte, graphite and lithium in this second circuit K2 is lower. Advantages: the process water W can be circulated for longer without interim cleaning; the water circuit represents a second cleaning stage, and so the residual concentration is negligibly low.

### D1 Dewatering of Coarse Fraction G

The coarse fraction C from step C2 (mixture of primarily cathode foils, anode foils, separator foils) is conveyed out of the first parting apparatus 32 continuously or discontinuously (and possibly already parted from the fine fraction, though this is not absolutely necessary). The conveying takes place presently by means of conveyor belts, although other methods are also possible (e.g., conveying screw, flushing out using process water). The coarse fraction C undergoes preliminary dewatering in the centrifuge 34 (different kinds of centrifuges are possible, discontinuous and continuous).

### D2 Drying of Coarse Fraction C

The coarse fraction C is dried in the drying device 42. The degree of drying is adjustable and is chosen in accordance with the subsequent sorting. Thermal drying, air drying or other methods are contemplated (stationary or continuous). Dewatering D1 and drying D2 are advantageous in the event of dry sorting D3. In the case of wet sorting, they can be omitted.

### D3 Sorting of Coarse Fraction (Wet or Dry)

Air classifying (dry or largely dry, air classifier 44). The coarse fraction C is sorted into different fractions (cathode foil, anode foil, separator, casing residues, others) in single-stage or multistage methods. Where appropriate, sub-fractions are formed (e.g., different size classes). Where appropriate, there are intermediate steps, such as balling of foils, by means of impact mill or the like, for example. Alternatives to the air classifying are optical sorting (dry or largely dry), magnetic separation, eddy current separation (dry or largely dry), wet sorting methods (sink/swim separation, flotation) and also magnetic separation, eddy current separation in the water.

D4 Preliminary Sorting/Preliminary Dewatering of Fine Fraction from Pretreatment

The fine fractions F from the step C2 are continuously or discontinuously discharged by means of the process water W and classified, by means of a sieve, for example, with one or more stages. We carry out wet sieving, although wet separation bench(es), dry sieving (if drying is carried out beforehand), centrifuging, hydrocyclone or similar methods are also contemplated in principle. The sieving stages serve at the same time for preliminary dewatering. Combinations of magnetic separation and/or eddy current separation in the wet medium are likewise possible, as are sedimentation methods. This produces one or more different fractions with different particle size and content.

D5 Dewatering/Filtering of Fine Fraction from Pretreatment

The various fractions from step D4 are thickened and further dewatered by means of filter devices 38 (e.g., vacuum, inclined filter, chamber filter press, or others). For each fraction, filter cakes are formed having a consistency, in terms of residual moisture, which may vary (i.e., filter cake consists of/contains very largely the active material of the anode (graphite)).

### D6 Drying/Further Treatment of Fine Fraction

The various fractions from step D5 are dried. The degree of drying is adjustable and is chosen in line with the requirements of the customer. Thermal drying, air drying or other methods are employed (stationary or continuous). Pressing or other methods may be used for compacting and packing the material.

### E1 Aftertreatment of the Cathode Foils (Cathode Delamination)

The “cathode foils” fraction from step D3 is supplied to a further shockwave facility (2nd parting apparatus 40, with low pulse energy), in which the active material (e.g., NMC, LFP, NCO, . . . ) is parted from the electrode carrier (generally aluminum foil).

The steps E1 and F1 to F6 are connected by a common process water circuit. The advantages 1, 2 and 6 from B1 are applicable here as well (3, 4 and 5 are no longer relevant, since electrolytes and charge have been removed in the previous steps). If the process steps B, C and D or parts thereof are traversed beforehand, the concentration of electrolytes, graphite and lithium in this 3rd water circuit is very low. Advantage: the process water can be circulated for longer without interim cleaning.

### E2 Sorting

After step E1, the materials are discharged into one or more circuits and separated into various fractions. The aim is on the one hand to achieve maximum accumulation of the active cathode material (NMC) in one or more fractions and on the other hand to accumulate the carrier foil (typically aluminum) in other fractions. Sieve classifying is used preferably (wet), and possibly supplementarily centrifuging. Alternatives to this are sieve classification (dry), sink-swim sorting, flotation, magnetic sorting (possibly for LFP).

### E3 Preliminary Dewatering/Removal of Extraneous Substances

With the aid of centrifuges or other technologies (sedimentation, sink-swim methods, flotation), any further extraneous substances are removed from the fractions and preliminary dewatering is performed in the same step or in further steps.

For removal of extraneous substances, further auxiliaries (chemical, mechanical) may also be added (e.g., precipitants, e.g. aqueous sodium hydroxide, e.g. catalytic substances). These substances may also be added already in an earlier step, or even at the start of the overall wet process (B1).

### E4 Dewatering

The various fractions from step D4 are thickened and further dewatered by means of filter units (e.g., vacuum, inclined filter, chamber filter press, or others). For each fraction, filter cakes are formed having a consistency, in terms of residual moisture, which may vary. Pressing or other methods may be used for compacting and packing the material.

### E5 Drying/Further Treatment

The various fractions from step D5 are dried. The degree of drying is adjustable and is chosen in line with the requirements of the customer. Thermal drying, air drying or other methods are employed (stationary or continuous). Pressing or other methods may be used for compacting and packing the material.

### W1 Process Water Aftertreatment

### Circuits

Process water W is the medium of many of the aforementioned process steps. It is reused in each case in separate and/or coupled circuits. Process water W from the second parting apparatus 40 (step (F1, F2 . . . )) is preferably used subsequently in the first parting apparatus 32 (step (C2, D . . . )), and is preferably used additionally thereafter in the pre-comminution (B1, B2), to allow the water to be utilized for as long as possible.

From one or more circuits, a part of the process water is subtracted in each case (continuously or discontinuously), in order for the dissolved or suspended substances of value to be withdrawn and recovered from the water.

### W2 Process Water Cleaning

Process water from one or more of the aforementioned circuits K1, K2, K3 is cleaned in a multistage process. The objects are:
(1) To render the process water reusable, and/or
(2) To render the process water introducible; and/or
(3) To recover substances of value

Cleaning takes place in respect of suspended and dissolved substances, in particular:
(1) Metals and heavy metals (e.g., Li, Al, Cu, Ni, Co, Mn, Fe, etc.)
(2) Other substances (e.g., P, F)
(3) Organic constituents (electrolytes, electrolyte salts)

The following processes are contemplated:
fine and ultrafine filtrations (ultrafiltration, reverse osmosis, high-performance disk filters, etc.)
activated carbon filters
other filter materials, e.g., such as blotting paper, glass fiber fleeces, fabrics
electrical and/or electrochemical processes
mechanical processes
chemical processes (flocculation and precipitation)
vacuum evaporation
adsorption materials of ceramic origin

### W3 Lithium Recovery

Lithium is recovered again from the remaining process water W.

Advantages of the method:
State of charge is used to adjust the amount of lithium ending up in the process water W (charged→major part of the lithium present as the ion, i.e., is leached from graphite and electrolyte; uncharged→major part of the lithium bound in the NMC, is leached to less of an extent)
Concentration far higher than in natural Li deposits

Applicable processes: possibly ultrafiltration, reverse osmosis; precipitation; electrochemical

### W4 Waste Air Cleaning and Substance Recovery—Wet & Dry

The atmosphere over the wet and dry process steps is preferably drawn off continuously or discontinuously and subjected to measurement and cleaning.
The objects are to observe and monitor emissions requirements, and get back substances of value

The following processes are available:
sedimentation
activated carbon filtering
electrochemical
chemical

The following is a summary list of reference numerals and the corresponding structure used in the above description of the invention:
20 facility
22 shredder
24 stirrer
26 conveying device
28 collecting container
30 processing device
32 first electrohydraulic parting apparatus
34 centrifuge
36 sieving apparatus
38 filter device
40 second parting apparatus
42 drying device
44 air classifier
50 third electrohydraulic parting apparatus
52 further centrifuge
Z cells
W process water
K1 first circuit
K2 second circuit
K3 third circuit
G graphite
S1 shredder fraction
S2 separator fraction
T1 first parting fraction
T2 second parting fraction
C coarse fraction
F fine fraction
F1 coarse fine fraction
F2 fine fine fraction
F3 ultrafine fraction
ZF comminuted fine fraction
CU copper fraction
AL aluminum fraction

1. A method for recycling battery cells or parts thereof that contain electrolytes and foils bearing coating material, the method comprising:
mechanically pre-comminuting the cells in liquid medium in a shredder stage to obtain a wet shredder fraction;
subsequently washing the wet shredder fraction in a preliminary separation stage, aided by a mechanical separator with exposure to mechanical energy and with use of the liquid medium, and in the process singulating the foils and washing out constituents of the shredder fraction, and accumulating the constituents in the liquid medium to obtain a separator fraction in the preliminary separation stage; and
subsequently processing the separator fraction in at least one parting stage.

2. The method according to claim 1, wherein the battery cells or the parts contain lithium and the foils are cathode foils with a coating of cathode material and anode foils with a coating of anode material, and the constituents washed out of the shredder fraction are electrolyte, coating material, and lithium.

3. The method according to claim 1, wherein the mechanical separator used in the preliminary separation stage is a stirrer having a stirring mechanism for stirring the shredder fraction.

4. The method according to claim 1, which comprises dewatering the wet separator fraction by removing a part of the liquid medium with the constituents contained therein to obtain a dewatered separator fraction.

5. The method according to claim 4, wherein the dewatering step comprises conveying the wet separator fraction via a conveying device to the first parting stage to thereby remove the liquid medium.

6. The method according to claim 4, which comprises recovering lithium and anode material from the liquid medium removed from the wet separator fraction.

7. The method according to claim 1, wherein the liquid medium is water.

8. The method according to claim 1, wherein a weight fraction of the liquid medium is greater by at least a factor of 10 than a weight fraction of the cells or parts of the cells supplied to the shredder stage.

9. The method according to claim 1, which comprises not discharging the cells before the shredder stage.

10. The method according to claim 1, which comprises bringing the cells to a defined state of charge before the shredder stage, and thereby selecting the defined state of charge from the group consisting of at least 30%, at least 50%, at least 75%, and at least 90% of a maximum state of charge thereof.

11. The method according to claim 4, which comprises supplying the dewatered separator fraction in the at least one parting stage to a first electrohydraulic parting apparatus and detaching at least one of the coatings from the foils to obtain a first parting fraction.

12. The method according to claim 11, which comprises parting the first parting fraction into two fractions, being a coarse fraction containing coarse foil parts and a fine fraction containing the removed coating material, and separately processing the two fractions.

13. The method according to claim 12, which comprises parting anode foils and cathode foils from one another from the coarse fraction, and supplying one foil fraction from which the coating material was not removed in the first parting stage to a second parting stage, and in the second parting stage removing the coating material from the foils of the one foil fraction, and thereby employing a second electrohydraulic parting apparatus to obtain a second parting fraction.

14. The method according to claim 13, which comprises supplying at least parts of the fine fraction and/or of the second parting fraction to a further comminution stage having a further electrohydraulic parting apparatus, to obtain a comminuted fine fraction.

15. The method according to claim 14, which comprises classifying the fine fraction and/or the second parting fraction into different fine fractions, and supplying at least one of the differently classified fine fractions to the further comminution stage to obtain the comminuted fine fraction.

16. The method according to claim 12, which comprises supplying one fraction selected from a fine fraction, a parting fraction, a comminuted fine fraction, or a classified fine fraction to a further separation stage, and separating in the further separation stage different kinds of particles contained in the one fraction from one another.

17. The method according to claim 1, which comprises providing a plurality of separate or interconnected circuits for the liquid medium, and recovering from the liquid medium at least one of lithium or graphite.

18. The method according to claim 1, which comprises conducting the liquid medium via a first circuit to the shredder stage and through a preliminary separation stage and back again.

19. The method according to claim 1, which comprises supplying at least a part of the liquid medium to a processing device in which at least one of lithium or graphite is deposited.

20. A facility for recycling secondary battery cells or parts thereof that comprise an electrolyte, lithium, and foils bearing coating material, the facility comprising:
a shredder stage configured for mechanically pre-comminuting the cells to obtain a shredder fraction;
a preliminary separation stage with a separator configured for obtaining a separator fraction by washing and parting constituents of the shredder fraction, the constituents being electrolyte and coating material, and by singulating the foils; and
a first parting stage with a first electrohydraulic parting apparatus configured for further processing the separator fraction obtained in the preliminary separation stage.
